(19) United States
(12) Patent Application Publication
(10) Pub. No.: US 2014/0168386 A1
(43) Pub. Date: Jun. 19, 2014

(54) PROJECTION SYSTEM AND PROJECTION METHOD THEREOF

(71) Applicant: DELTA ELECTRONICS, INC., Taoyuan Hsien (TW)

(72) Inventor: Yuan-Ming Hsu, Taoyuan Hsien (TW)

(73) Assignee: DELTA ELECTRONICS, INC., Taoyuan Hsien (TW)

(21) Appl. No.: 13/774,775

(22) Filed: Feb. 22, 2013

(30) Foreign Application Priority Data
Dec. 18, 2012 (TW) 101148164

(51) Int. Cl. H04N 13/02

(52) U.S. Cl. CPC H04N 13/0203
USPC 348/49

(57) ABSTRACT

A projection system includes a control module, a first image capture module, a second image capture module, an image processing module and a projection module. The first and second image capture modules are connected to the control module and include first and second sensor elements and first and second lenses, respectively. The image processing module is connected with the control module, the first image capture module and the second image capture module for transforming the image into a three-dimensional image signal. The projection module is connected with the control module for projecting. The first sensor element and the second sensor element are selectively controlled by the control module to capture images through the first lens and the second lens, respectively. The three-dimensional image signal transformed by the image processing module is processed and converted by the control module, and further projected by the projection module.

### FIELD OF THE INVENTION

The present invention relates to a projection system, and more particularly to a projection system and a projection method thereof.

### BACKGROUND OF THE INVENTION

With growing of technologies, a lot types of projection apparatus are widely used in homes, schools and business occasions (e.g. projectors), among which the projectors are used for projecting a video corresponding to a video signal provided by a video signal source on a screen. In recent years, the technologies grow day by day, so the user demands also increase. Besides the function of two-dimensional planar projection, the projectors are expected to have the function of three-dimensional projection.

Conventionally, a sensor element of a projection system is used in a conventional real object projector for capturing an image of a real object, and a projection module is used for projecting. Please refer to FIGS. 1 and 2. FIG. 1 schematically illustrates the configuration of a projection system of a conventional real object projector of prior art. FIG. 2 schematically illustrates a flow chart of a projection method of a conventional real object projector of prior art. The projection system 1 of a conventional real object projector includes an image capturing and processing module 11, a control module 12 and a projection module 13, among which the image capturing and processing module 11 includes a control unit 111, a sensor element 112, a lens 113 and a two-dimensional image processing unit 114, and the control module 12 includes a driving signal converter 121. A projection method of the projection system 1 of the conventional real object projector includes steps as follows: as shown in step S1, allowing the control unit 111 to control the sensor element 112 to capture a real object as an image through the lens 113; allowing the two-dimensional image processing unit 114 to optimize the image and generate a video signal as shown in step S2; allowing the control module 12 to process the video signal and generate a projection data as shown in step S3; and as shown in step S4, allowing the driving signal converter 121 to convert the projection data and allowing the projection module 13 to project.

In general, the projection system 1 and the projection method of the conventional real object projector mentioned above sample and capture a three-dimensional real object to be presented, which means the projection source may be not only a slide or a document, but also a three-dimensional object. However, by way of the conventional projection method, the image is captured by the single sensor element 112 and optimized by the two-dimensional image processing unit 114. Even if the projection source is a three-dimensional object, the projection presented by the projection module 13 is still a two-dimensional projection (i.e. a planar projection) but not a three-dimensional projection. Certainly, the user requirements cannot be satisfied by the conventional real object projector. Moreover, in some situations such like demonstrating, teaching or healing, the drawbacks of two-dimensional projection are highlighted because the two-dimensional projection cannot present the reality and the stereognosis of the real object. The real size and ratio of the real object cannot be presented because of limitations of image capturing angle, distance and photosensitivity.

There is a need of providing a projection system and a projection method thereof to obviate the drawbacks encountered from the prior art.

### SUMMARY OF THE INVENTION

The present invention provides a projection system and a projection method thereof in order to eliminate the drawbacks caused by the two-dimensional projection, such like that the reality, the stereognosis, the real size and the real ratio cannot be presented by the two-dimensional projection of projection system of conventional real object projector.

The present invention also provides a projection system and a projection method thereof. An image is captured by a first image capture module and a second image capture module and transformed into a three-dimensional image signal by an image processing module. Under this circumstance, a three-dimensional image is projected, the user demands are met, and the reality and the stereognosis are effectively presented.

The present invention further provides a projection system and a projection method thereof. Via a first image capture module and a second image capture module with two sensor elements and two lenses, the human vision is simulated and the real size and ratio of an real object are precisely presented.

In accordance with an aspect of the present invention, there is provided a projection system. The projection system includes a control module, a first image capture module, a second image capture module, an image processing module and a projection module. The first image capture module is connected with the control module. The first image capture module includes a first lens and a first sensor connected with the first lens for capturing an image. The second image capture module is connected with the control module. The second image capture module includes a second lens and a second sensor element connected with the second lens for capturing the image. The image processing module is connected with the control module, the first image capture module and the second image capture module for transforming the image into a three-dimensional image signal. The projection module is connected with the control module for projecting. The first sensor element and the second sensor element are selectively controlled by the control module to capture the image through the first lens and the second lens, respectively. The three-dimensional image signal transformed by the image processing module is processed and converted by the control module, and further projected by the projection module.

In accordance with another aspect of the present invention, there is provided a projection method. The projection method includes steps as follows: providing a three-dimensional object and a projection system, among which the projection system includes a first image capture module, a second image capture module, an image processing module, a control module and a projection module; capturing the three-dimensional object as an image; transforming the image into a three-dimensional image signal; processing and converting the three-dimensional image signal; and allowing the projection module to project.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the configuration of a projection system of a conventional real object projector of prior art;

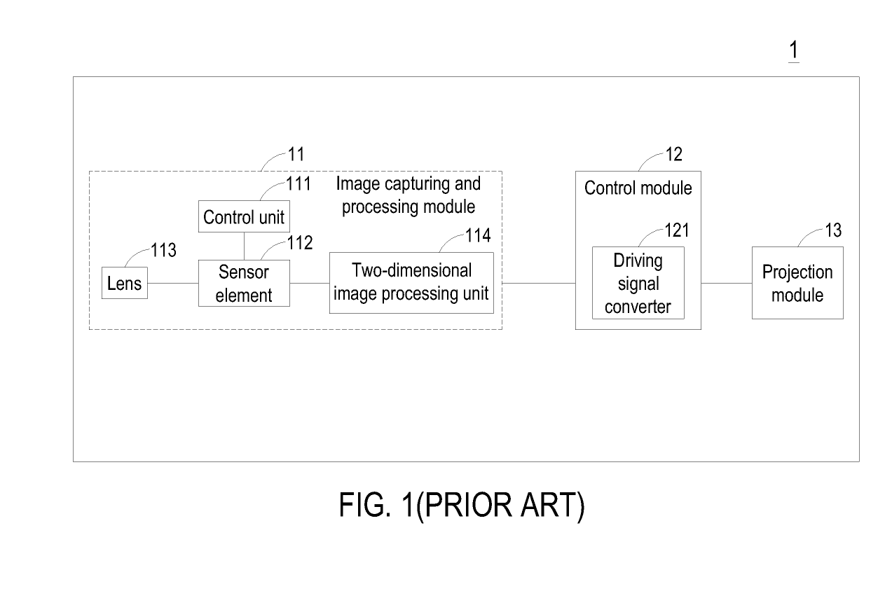

FIG. 2 schematically illustrates a flow chart of a projection method of a conventional real object projector of prior art;

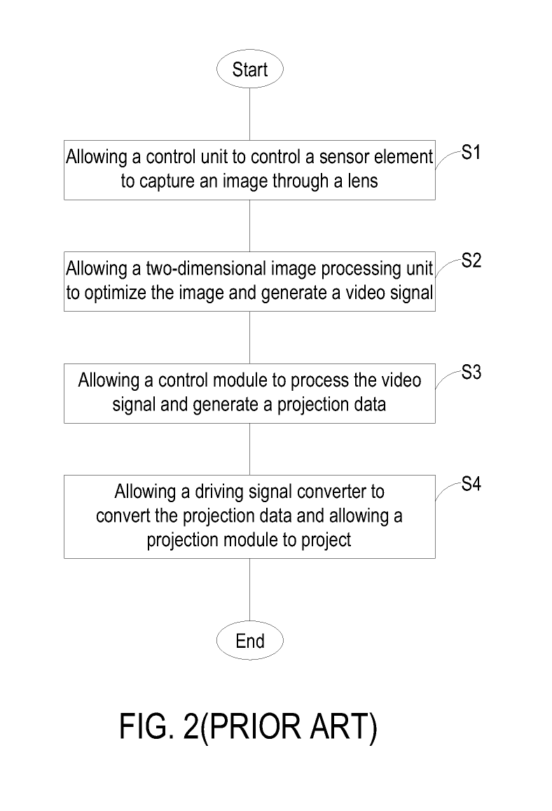

FIG. 3 schematically illustrates the configuration of a projection system according to an embodiment of the present invention;

FIG. 4 schematically illustrates the detailed configuration of a projection system according to an embodiment of the present invention; and

FIG. 5 schematically illustrates a flow chart of a projection method according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

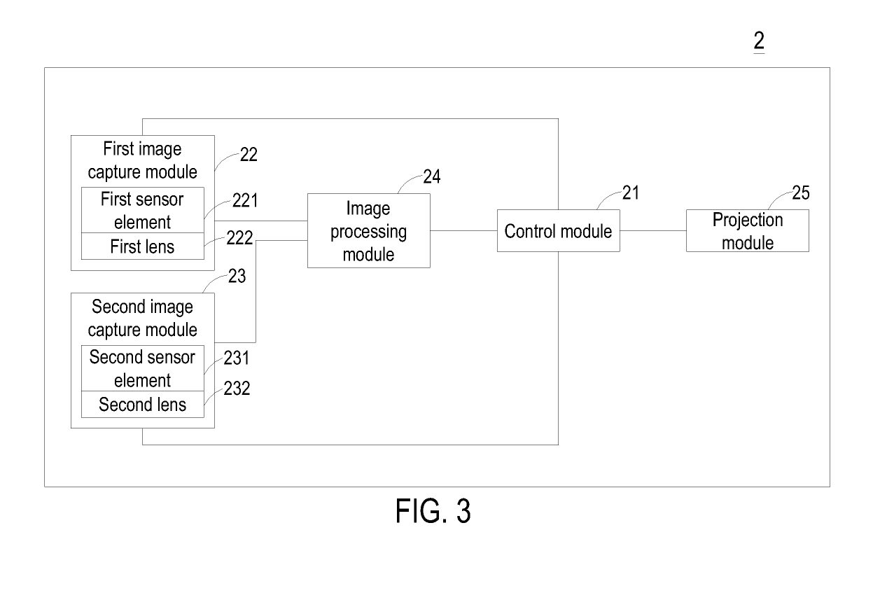

Please refer to FIG. 3. FIG. 3 schematically illustrates the configuration of a projection system according to an embodiment of the present invention. The projection system 2 of the present invention is applied to a three-dimensional real object projector and includes a control module 21, a first image capture module 22, a second image capture module 23, an image processing module 24 and a projection module 25. The control module 21 is connected with the first image capture module 22, the second image capture module 23, the image processing module 24 and the projection module 25 for controlling the whole operation of the projection system 2. The projection module 25 is utilized for projecting. The first image capture module 22 includes a first sensor element 221 and a first lens 222. The first sensor element 221 is connected with the first lens 222 for capturing a real object as an image. The second image capture module 23 includes a second sensor element 231 and a second lens 232. The second sensor element 231 is connected with the second lens 232 for capturing the real object as the image. The first sensor element 221 and the second sensor element 231 are selectively controlled by the control module 21 to capture the image through the first lens 222 and the second lens 232, respectively. The image processing module 24 is connected with the control module 21, the first image capture module 22 and the second image capture module 23 for transforming the image captured by the first sensor element 221 or the second sensor element 231 into a three-dimensional image signal. The three-dimensional image signal transformed by the image processing module 24 is processed and converted by the control module 21, in which the location, the depth, the angle, the size and the ratio of a three-dimensional image are constructed and a signal format compatible with the projection module 25 is generated (i.e. converted or transformed) for instantly real-time three-dimensional projection. The projection module 25 is then allowed to project the three-dimensional image. As a result, the user demands are met, and the reality and the stereognosis are effectively presented by the projection system 2 of the present invention.

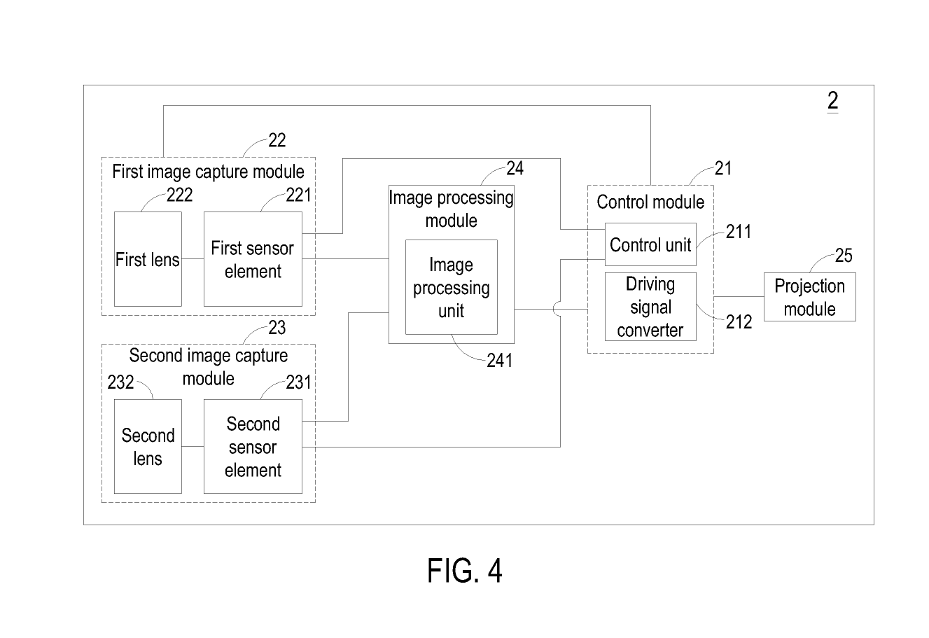

Please refer to FIG. 4. FIG. 4 schematically illustrates the detailed configuration of a projection system according to an embodiment of the present invention. As shown in FIG. 4, the control module 21 further includes a control unit 211 and a driving signal converter 212. The driving signal converter 212 is utilized for converting the three-dimensional image signal, in which the three-dimensional image signal is converted into a signal format compatible with the projection module 25 by the driving signal converter 212 for real-time projection. The control unit 211 is connected with the first sensor element 221 of the first image capture module 22 and the second sensor element 231 of the second image capture module 23 for controlling the first sensor element 221 to capture the image through the first lens 222 or controlling the second sensor element 231 to capture the image through the second lens 232. In this embodiment, the first sensor element 221 of the first image capture module 22 and the second sensor element 231 of the second image capture module 23 are not limited to CMOS sensor elements, and are selectively controlled by the control unit 211 to capture a complete image, to be disabled, or to capture parts of the image respectively.

In some embodiments, the image is captured by the first sensor element 221 of the first image capture module 22 through the first lens 222 or captured by the second sensor element 231 of the second image capture module 23 through the second lens 232, and transmitted to the image processing module 24. The image is transformed into a three-dimensional image signal by the image processing module 24. The three-dimensional image signal transformed by the image processing module 24 is received and processed by the control module 21, such that the data such like location, depth, angle, size and ratio of a three-dimensional image are constructed, but not limited thereto. After the image processing of the control module 21, the constructed three-dimensional image is converted into a signal format compatible with the projection module 25, and then projected by the projection module 25. Therefore, a real-time three-dimensional projection is implemented instantly.

In some embodiments, the image processing module 24 further includes an image processing unit 241. The image processing unit 241 is not limited to a 2D-to-3D video processing unit, and an algorithm is used for transforming the image into the three-dimensional image signal by the image processing unit 241. For example, a two-dimensional image is captured by the first image capture module 22 and/or the second image capture module 23 and transformed into the three-dimensional image signal through the algorithm by the image processing unit 241. The three-dimensional image signal is processed, converted and projected by the control module 21 and the projection module 25, in which the concept is similarly to the above embodiments, and is not redundantly described herein.

On the other hand, the human vision can be simulated by the projection system 2 of the present invention and the three-dimensional image with more precise location and depth can be constructed. To simulate the human vision, the image is preferably consisted by a first partial image and a second partial image. The first sensor element 221 of the first image capture module 22 and the second sensor element 231 of the second image capture module 23 are selectively started at the same time for capturing the real object as the image. A first partial image (e.g. a left-eye image) is captured through the first lens 222 by the first sensor element 221, and a second partial image (e.g. a right-eye image) is captured through the second lens 232 by the second sensor element 231. The first partial image and the second partial image are consisted to be the image, but not limited thereto. The image is transformed into the three-dimensional image signal according to the first partial image and the second partial image by the image processing unit 241 of the image processing module 24. For example, the first partial image and the second partial image are transmitted by the first image capture module 22 and the second image capture module 23 and received by the image processing module 24. The image is consisted, constructed and further transformed into the three-dimensional image signal. The three-dimensional image signal is received, converted and processed by the control module 21, such that the data such like location, depth, angle, size and ratio of the three-dimensional image are constructed, but not limited thereto. After the image processing and converting of the control module 21, the constructed three-dimensional image is converted into a signal format compatible with the projection module 25, and then projected by the projection module 25. As a result, a real-time three-dimensional projection is implemented instantly.

In this embodiment, the image processing unit 241 of the image processing module 24 is not limited to a 3D video processing unit, and the first partial image captured by the first image capture module 22 and the second partial image captured by the second image capture module 23 are consisted and constructed to be the image with 3D format. The image including the first partial image and the second partial image is transformed into the three-dimensional image signal by way of stacking, overlaying, space locating, depth computing and/or angle computing. The three-dimensional image signal is processed, converted and projected by the control module 21 and the projection module 25, in which the concept is similarly to the above embodiments, and is not redundantly described herein. Therefore, the human vision can be simulated by the projection system 2 of the present invention and the three-dimensional image with more precise size and ratio can be presented.

Furthermore, an assembly of a sensor element and a lens can be disabled according to the requirement. In some embodiments, the first sensor element 221 and the first lens 222 or the second sensor element 231 and the second lens 232 is selectively disabled by the control module 21, and the image is captured through the second lens 232 by the second sensor element 231 or captured through the first lens 222 by the first sensor element 221. For example, when a user wants to use the projection system 2 of the present invention for implementing a document projection, which is not limited to a slide projection, a paper projection or a textbook projection, the first sensor element 221 and the first lens 222 of the first image capture module 22 or the second sensor element 231 and the second lens 232 of the second image capture module 23 can be selectively disabled since the documents do not have the characteristics such like location, depth, angle and stereognosis. The image of a document is captured through the second lens 232 by the second sensor element 231 or captured through the first lens 222 by the first sensor element 221, and transformed into a three-dimensional image signal by the image processing module 24. The three-dimensional image signal is processed, converted and projected by the control module 21 and the projection module 25. Because the source document is a 2D planar document, the three-dimensional image signal is substantially an image signal with one dimension fixed. The projection image is substantially a two-dimensional image with the other dimension fixed and is for example a document projection image, among which the document projection image is perpendicular to the ground plane but not limited thereto.

Certainly, an assembly of a sensor element and a lens can also be disabled according to the requirement when implementing a three-dimensional real object projection. For example, the image captured by the first sensor element 221 and the first lens 222 or the second sensor element 231 and the second lens 232 is transformed into the three-dimensional image signal by using an algorithm of the image processing unit 241 as the above-mentioned embodiments.

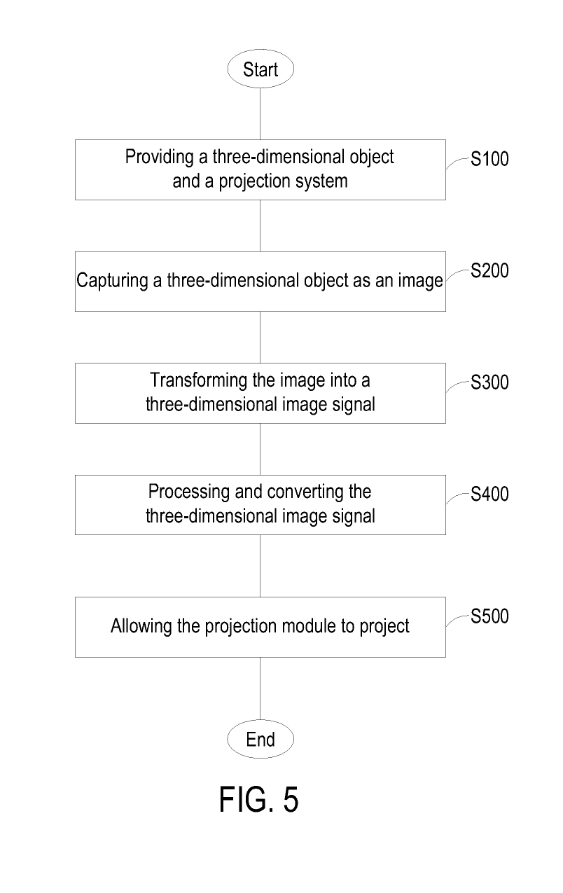

Please refer to FIGS. 3 and 5. FIG. 5 schematically illustrates a flow chart of a projection method according to an embodiment of the present invention. The projection method of the present invention comprises steps as follows. First of all, providing a three-dimensional object and a projection system 2 as shown in step S100, among which the projection system 2 includes a control module 21, a first image capture module 22, a second image capture module 23, an image processing module 24 and a projection module 25. Next, capturing the three-dimensional object as an image as shown in step S200, or capturing the three-dimensional object as a first partial image and a second partial image in some embodiments. Then, transforming the image into a three-dimensional image signal as shown in step S300. Next, processing and converting the three-dimensional image signal as shown in step S400. Finally, allowing the projection module 25 to project as shown in step S500. In the embodiments of capturing a first partial image and a second partial image, the first partial image and the second partial image are consisted and constructed to be the image, which means that the image includes the first partial image and the second partial image, but is not limited thereto.

From the above description, the present invention provides a projection system and a projection method thereof. An image is captured by a first image capture module and a second image capture module and transformed into a three-dimensional image signal by an image processing module. Under this circumstance, a three-dimensional image is projected, the user demands are met, and the reality and the stereognosis are effectively presented. On the other hand, via a first image capture module and a second image capture module with two sensor elements and two lenses, the human vision is simulated and the real size and ratio of an real object are also precisely presented.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A projection system, comprising:
a control module;
a first image capture module connected with said control module, wherein said first image capture module comprises a first sensor element and a first lens, and said first sensor element is connected with said first lens for capturing an image;
a second image capture module connected with said control module, wherein said second image capture module comprises a second sensor element and a second lens, and said second sensor element is connected with said second lens for capturing said image;
an image processing module connected with said control module, said first image capture module and said second image capture module for transforming said image into a three-dimensional image signal; and
a projection module connected with said control module for projecting,
wherein said first sensor element and said second sensor element are selectively controlled by said control module to capture said image through said first lens and said second lens, respectively, and said three-dimensional image signal transformed by said image processing module is processed and converted by said control module and projected by said projection module.

2. The projection system according to claim 1 wherein said control module further comprises a control unit, and said control unit is connected with said first sensor element of said first image capture module and said second sensor element of said second image capture module for controlling said first sensor element to capture said image through said first lens or controlling said second sensor element to capture said image through said second lens.

3. The projection system according to claim 1 wherein said image processing module further comprises an image processing unit, and an algorithm is used for transforming said image into said three-dimensional image signal by said image processing unit.

4. The projection system according to claim 1 wherein said first sensor element and said second sensor element are selectively started at the same time for capturing said image, and wherein a first partial image is captured through said first lens by said first sensor element, a second partial image is captured through said second lens by said second sensor element, and said image is consisted by said first partial image and said second partial image.

5. The projection system according to claim 4 wherein said image processing module further comprises an image processing unit, and said image is transformed into said three-dimensional image signal according to said first partial image and said second partial image by said image processing unit.

6. The projection system according to claim 1 wherein said first sensor element or said second sensor element is selectively disabled, and said image is captured through said second lens by said second sensor element or captured through said first lens by said first sensor element.

7. The projection system according to claim 6 wherein said three-dimensional image signal is an image signal with one dimension fixed.

8. The projection system according to claim 1 wherein said control module further comprises a driving signal converter, and said three-dimensional image signal is converted into a signal format compatible with said projection module by said driving signal converter for real-time projection.

9. A projection method, comprising steps:
providing a three-dimensional object and a projection system, wherein said projection system comprises a first image capture module, a second image capture module, an image processing module, a control module and a projection module;
capturing said three-dimensional object as an image;
transforming said image into a three-dimensional image signal;
processing and converting said three-dimensional image signal; and
allowing said projection module to project.

10. The projection method according to claim 9 wherein one of said first image capture module and said second image capture module is selectively disabled, and said image is captured by said second image capture module or said first image capture module.

11. The projection method according to claim 9 wherein said first image capture module and said second image capture module are selectively started at the same time, a first partial image and a second partial image are captured by said first image capture module and said second image capture module, respectively, and said image is consisted by said first partial image and said second partial image.
